(19) United States
(12) Patent Application Publication
(10) Pub. No.: US 2006/0064759 A1
(43) Pub. Date: Mar. 23, 2006

(54) Method and apparatus for controlling access to downloadable content

(75) Inventor: Ian Agranat, Concord, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Wildlife Acoustics, Inc., Concord, MA (US)

(21) Appl. No.: 10/947,089

(22) Filed: Sep. 22, 2004

(51) Int. Cl. H04N 7/16

(52) U.S. Cl. 726/26

(57) ABSTRACT

A method of access control in which an authority may limit the content a client may download to a trusted device comprises: the authority making content, and a content descriptor containing information about the content, available to a client; the authority providing an access key to a client; the client presenting the access key and a requested content descriptor to a trusted device for download; and the trusted device accepting or rejecting the requested download as determined by the access key and content descriptor presented. Numerous variations are possible. Apparatus for limiting distribution of content obtained together with an access key in which a shared secret is encoded from a computer executing a server process comprises: a trusted device including a verifier that verifies the encoded shared secret and a content acceptor that only accepts content when the shared secret is verified. The access key may include a message digest covering the shared secret in which case the trusted device may further comprise: a message digest encoded into which information including the shared secret is fed and which produces a message digest for comparison the access key.

### RELATED APPLICATIONS

This application is related to U.S. application Ser. No. 10/767,801 entitled “METHOD AND APPARATUS FOR AUTOMATICALLY IDENTIFYING ANIMAL SPECIES FROM THEIR VOCALIZATIONS,” filed on Jan. 29, 2004, and Attorney Docket No. A2002-700030, entitled “METHOD AND APPARATUS FOR AUTOMATICALLY IDENTIFYING ANIMAL SPECIES FROM THEIR VOCALIZATIONS,” filed on Jul. 30, 2004, which are herein incorporated by reference in their entirety.

### BACKGROUND OF INVENTION

Intelligent devices such as cell phones, multimedia players and recorders, digital cameras, set-top boxes, and many others are becoming increasingly pervasive. Intelligent devices means devices including a processor executing software or firmware instructions to accomplish a task. Many of these devices are capable of receiving downloads such as software updates, plug-in functionality modules, multi-media including audio and video, configuration information, and other kinds of content. In many cases, it is desirable to control access to the downloadable content by the intelligent device. For example, a business may wish to sell subscriptions to downloadable content. In that case, the business would possibly want to restrict redistribution of the content from devices not belonging to subscribers.

Traditionally, access control for downloadable content for devices has been based on restricting access to these downloads by the client or end-user. However, this method has several disadvantages. First, because downloadable content typically needs to be stored on a secure server, it is not always available if connectivity between the client and server is lost. Second, once the content has been downloaded to one client, it is difficult to prevent that content from being shared freely with other clients. Third, the server is required to maintain information about each client and to participate actively in each download transaction adding cost in storage and processing power, particularly if individualized encryption is used to prevent the sharing problem just described. And fourth, it is easier to attack the security of a general purpose computer than a closed system like a typical intelligent device. Other disadvantages of conventional methods will also be apparent upon reading the advantages of the present invention.

### SUMMARY OF INVENTION

Aspects of some embodiments of the invention move the responsibility for enforcing the access control policy from the authority server to the device itself, eliminating one or more of the disadvantages described above, as well as others that will be evident to the skilled artisan.

By virtue of the design of the intelligent device and the architecture in which it is used, aspects of embodiments of the present invention provide a mechanism by which an authority can control a client's ability to download content to the device, where the client is either an end-user, or an agent working on behalf of the end-user.

Aspects of embodiments of the present invention provide a method of access control for restricting download content to a device. But rather than restrict the client or the device from accessing the content directly, the intelligent device enforces the access control policy after content is downloaded at least to the client, instead. An authority generates a forgery resistant access key and provides the key to the client, preferably at the time content or a subscription for content is purchased. Thus, the authority need not store subscription information. The client, in turn, provides the access key to the device. When the client attempts to download content to the device, the device verifies the content against the access key and accepts or refuses the download request according to the policy defined by the access key. To facilitate the verification, the content is accompanied by a forgery resistant content descriptor.

According to one example embodying aspects of the invention, it is desirable to sell annual subscriptions for software updates, and then restrict downloads to only those updates made available before a subscription expires. It is also desirable to sell access to a subset of available downloads such as audio or video, while restricting access to those downloads that have not been paid for. It is yet further desirable to combine both a time-based subscription and a subset-based class of downloads. In an alternative embodiment, the download itself may be permitted, but the device enforces a policy of not using unauthorized content. Such content could be downloaded for later use, when a proper authorization is received.

A method of access control in which an authority may limit the content a client may download to a trusted device comprises: the authority making content, and a content descriptor containing information about the content, available to a client; the authority providing an access key to a client; the client presenting the access key and a requested content descriptor to a trusted device for download; and the trusted device accepting or rejecting the requested download as determined by the access key and content descriptor presented. Numerous variations are possible. For example, the access key may contain a message digest. The message digest may include a secret known to the authority and to the trusted device. The trusted device may contain an identifier; the trusted device providing the identifier to the client; the client providing the identifier to the authority; and the authority using the identifier in generating the access key such that the access key is only valid for trusted devices with the same identifier. When using an identifier, the identifier may be unique, such that the access key is only valid for a specific trusted device. In some variations, the access key contains a message digest and the message digest includes the identifier. In some variations, the content descriptor is integrated with the corresponding content. The content descriptor may contain a digest including all or part of the content.

The content descriptor may contain a digest including all or part of the content descriptor. In any embodiment including a message digest, the digest may include a secret known to the authority and the trusted device. Furthermore, the content may be encrypted by a secret known to the authority and the trusted device. The content descriptor may contain a list of one or more access classes and the access key may contain a list of one or more allowed access classes, such that the trusted device will allow access if the content's access classes are included in the access key. For example, the access key may contain a digest, including the list of allowed classes. The content descriptor may contain a content creation date and the access key may contain an expiration date, such that the trusted device will deny access if the content creation date is newer than the expiration date. For example, the access key may contain a message digest including the expiration date. In some embodiments, the client may be integrated with the trusted device. The content may be stored on removable storage media or on fixed storage media. In some embodiments, the content may be stored on a server, the server connected to a communications network, and the client able to download the content across the network. The client may be able to save the content locally for later retrieval.

Apparatus for limiting distribution of content obtained together with an access key in which a shared secret is encoded from a computer executing a server process comprises: a trusted device including a verifier that verifies the encoded shared secret and a content acceptor that only accepts content when the shared secret is verified. The access key may include a message digest covering the shared secret in which case the trusted device may further comprise: a message digest encoded into which information including the shared secret is fed and which produces a message digest for comparison the access key.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a system architecture embodying aspects of the invention;

FIG. 2 is a data flow diagram showing the generation and subsequent testing of message digest information for veracity;

FIG. 3 is a block diagram of a computer system suitable for practicing the invention, and

FIG. 4 is a block diagram of the storage system of the computer system of FIG. 3.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

The present invention provides a method of access control capable of restricting content downloads to a designated intelligent device. The intelligent device is any device capable of receiving and processing a content download, where content may include software programs such as firmware updates or plug-in functionality, as well as data which could include multi-media objects such as audio and video recordings, configuration information, or any other data that may facilitate the particular functionality of the device.

An intelligent device is the device designed for a particular purpose disclosed in Applicant's co-pending U.S. patent application Ser. No. 10/767,801 entitled “METHOD AND APPARATUS FOR AUTOMATICALLY IDENTIFYING ANIMAL SPECIES FROM THEIR VOCALIZATIONS,” and Applicant's co-pending U.S. patent application bearing Attorney Docket No. A2002-700030, entitled “METHOD AND APPARATUS FOR AUTOMATICALLY IDENTIFYING ANIMAL SPECIES FROM THEIR VOCALIZATIONS.” As mentioned above, numerous other devices suitable for a wide variety of applications may also embody the invention. For example, book readers, game consoles and other devices may be securely updated using aspects of the invention.

Rather than restrict a client's access to the content itself (a technique commonly employed in the prior art), embodiments of aspects the present invention entrust the device to enforce the access control policy of the authority. The device is therefore referred to as a “trusted device”. The access control technology is preferably embedded in hardware of the trusted device. Alternatively, part or all of the technology could be embodied in updatable software, provided doing so does not appreciably weaken the security provided. This approach has several advantages over the prior art. First, the content itself can be easily and widely distributed, without any special regard for security, on removable media such as CD-ROMs, FLASH cards, etc., or over a network using “open” or unencrypted protocols such as HTTP, FTP, etc. as well as encrypted media or using encrypted protocols. Second, once a client has a copy of the content, the client is still restricted from effectively sharing the content with unauthorized devices. Third, the authority does not need to maintain any knowledge of any specific client nor does the authority need to participate directly in the download authentication process. Fourth, the degree of difficulty in circumventing the security measures embedded in the trusted device is substantially higher than doing so on a general purpose computer system. Other advantages will become apparent to the skilled artisan upon reading this Detailed Description.

If the content is of a sensitive nature, it may be encrypted by the authority using a secret key known only to the authority and one or more trusted devices. Alternatively, encryption can be done using a public key provided to the authority by the trusted device, or looked up in a key repository, such that only a trusted device holding the corresponding private key can be decrypt the content. Other known cryptosystems can also be used, such as transmitting a one-time key using a public key cryptosystem, the one-time key being used to encrypt the content. Decryption would be performed inside the trusted device after receiving the downloaded content such that the decrypted content is never directly available outside of the device. Any suitable encryption algorithm or combination of algorithm could be utilized, including the well-known DES data encryption algorithm.

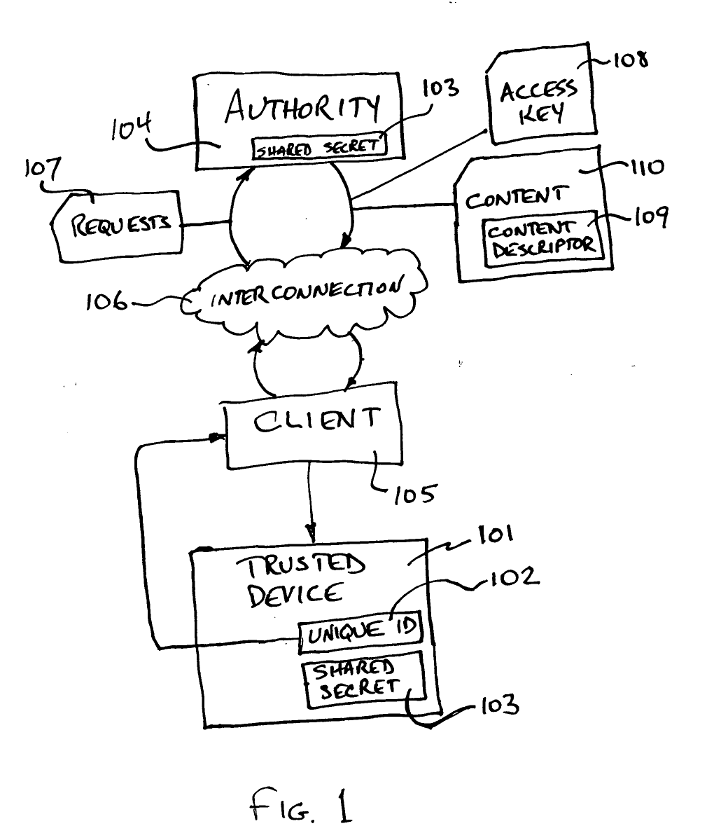

An example architecture illustrating aspects of embodiments of the invention is shown in FIG. 1. In this example, a trusted device 101 has a unique identification, for example a hardwired unique ID 102. The unique ID 102 may optionally be burnt into a read-only memory that is not separable from the trusted devices. In addition, the trusted device 101 also possesses a shared secret 103, i.e., some information shared in some way with an authority 104. The authority 104 is the source of content desired by the trusted device 101. The authority 104 is connected to the trusted device through a client 105 and interconnection 106. The authority 104 may be a server that responds to requests by the client 105, or another mechanism may be used. The client 105 may be embedded in the trusted device, or may be a separate hardware and/or software system, for example, a general purpose computer executing software defining a client process to which the trusted device 101 connects.

According to some embodiments of aspects of the invention, when a user of the trusted device 101 wishes to subscribe to download content available from the authority 104, the trusted device transmits a request 107 including its unique ID 102 through the client 105 to the authority 104. The unique ID 102 can be communicated by other methods according to other embodiments. For example, manual and semi-automatic modes may be used. A human operator could read a unique ID 102 affixed to the device 101. The device 101 could automatically provide the unique ID 102 to the client 105, which then displays the unique ID 102 to a human operator. Using these modes, the operator then communicates the unique ID 102 manually or otherwise to the authority 104.

The authority uses the unique ID 102 to generate an access key 108 which identifies the particular trusted device 101 by its unique ID 102, and includes information about the content to which the trusted device 101 is entitled, as well as information making the access key 108 relatively tamper and forgery resistant. The access key 108 can then be stored by the client 105 or the trusted device for further reference. Aspects of embodiments of the access key 108 are described in greater detail, below.

A content descriptor 109 is associated with each downloadable content object 110 that includes information about how the content may be restricted in accordance with an access control policy of the authority. For example, one access control policy may be that clients are permitted only to subscribe to particular content on a time-limited basis. The content descriptor 109 could then indicate the creation date of the content 110. If the client is to be authorized to access particular classes of content, the content descriptor 109 for that content 110 could indicate the classes associated with each unit of content.

Either the access key 108 or the content descriptor 109 or both, may contain a cryptographic message digest, such as that defined by the well-known MD5 message digest algorithm. Any suitable message digest algorithm may be used. The message digest may cover the content 110, the information used in the access control policy, and a secret 103 known only to the authority and to the trusted devices, to protect the content 110 and the content descriptor 109 from forgery and tampering.

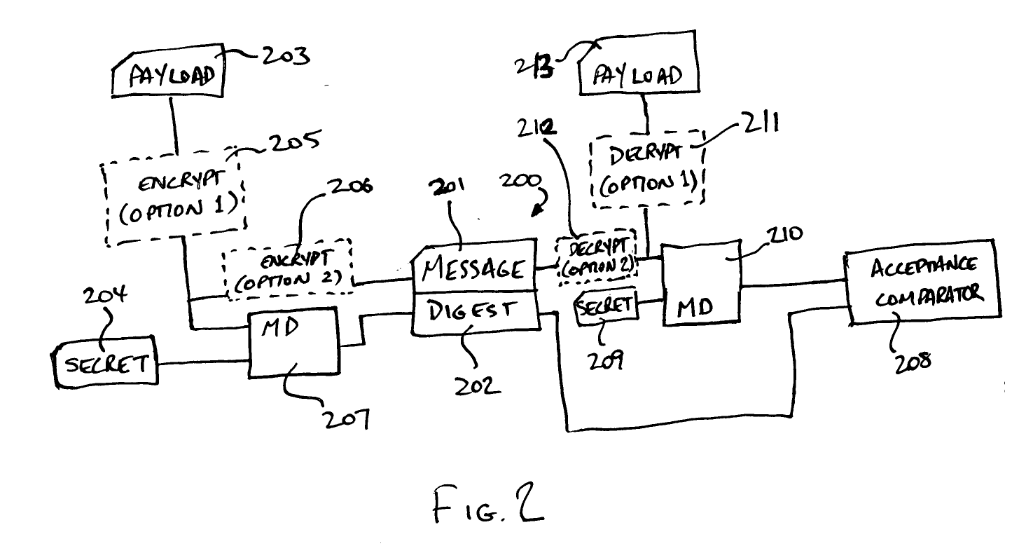

Access keys 108 and content messages 110 containing content descriptors 109 have similar data structures referred to hereinafter as protected messages. Each protected message 200 includes a message section 201 and a digest section 202 as shown in FIG. 2. The data flow and processing by which a payload and a shared secret are transformed into a forgery resistant message and digest, and then verified is now described.

The term payload 203 refers to information to be transmitted from the authority to the trusted device. The term shared secret 204 refers to information whose secret nature renders a protected message 200 carrying the payload 203 forgery resistant. The payload 203 is inserted into a message portion 201 of the protected message 200, optionally after encryption 205, 206 of the payload 203. The payload 203, which may have been encrypted at this point is also combined with the shared secret 204 using a message digest algorithm 207 to produce a message digest 202. The message digest 202 is then appended to the message portion 201 of the protected message 200 and transmitted therewith. When the protected message 200 is received, the digest 202 is stripped off and forwarded to one input of a comparator 208. The trusted device then takes the message portion 201 of the protected message 200 and its own local copy of the shared secret information 209 and combines them using the same message digest algorithm 210 used by the authority. The result is a digest which is forwarded to a second input of the comparator 208. The comparator 208 tests whether the trusted device has computed the same message digest as was transmitted to the trusted device by the authority. The message 201, which is decrypted if necessary 211, 212, then becomes the payload 213 to be used by the trusted device if the comparator 208 signals acceptance of the message 201. In the embodiments of the invention described herein, a high level of security is maintained, in part, because the data paths within the trusted device are relatively inaccessible to hacking. Therefore, the result of the comparison within the trusted device can be trusted.

If the content of the payload 203 is particularly sensitive, the payload 203 can optionally be encrypted in one of at least two different portions of the data path. According to a first option the payload 203 may be immediately encrypted 205 both before being inserted into the protected message 200 and before computing the message digest 207. In that case, the encrypted message must be applied to the message digest algorithm 210 in the trusted device. Decryption 211 is preferred outside the path to the message digest algorithm 210. This option is designated Option 1 205, 211, in FIG. 2. Alternatively, the payload 203 can be applied to the message digest algorithm 207 by the authority in unencrypted form while the payload 203 is also, in parallel, encrypted 206 as it is inserted into the protected message 200. In this instance, the message 201 must be decrypted 212 before it is applied to the message digest algorithm 210 by the trusted device so that the same information is processed by the message digest algorithm 210 of the trusted device as was processed by the message digest algorithm 207 of the authority. This option is designated Option 2, 206, 212, in FIG. 2.

Now, methods according to aspects of embodiments of the invention using the foregoing architecture are described.

When a user purchases content, or when the user subscribes to content, the authority generates and issues an access key to the client. The access key is a protected message, as described above. When the client attempts to download content to the trusted device, it provides the access key and the content message including the content descriptor to the trusted device. The content message is also a protected message. The trusted device may accept or deny the download request first on the basis of the authenticity of the access key and the content message, and then according to the access control policy specified by the access key and the information contained in the content descriptor.

Each trusted device may contain a unique identifier, such as a serial number, embedded in the hardware of the trusted device, or by other suitable means, that can be made available through the client. The authority may make use of this unique identifier in generating the access key such that the access key is only valid for the particular trusted device.

The protected message of the access key may contain a cryptographic message digest which covers the unique identifier, the access control policy, and a secret known only to the authority and to one or more of the trusted devices, such that the key can be authenticated by the trusted device, as described above.

For example, suppose a user of a particular client purchases a subscription to download “Class A” content for one year expiring on “May 18, 2005” for a trusted device with a serial number of “1234”. Further suppose that the trusted device and the authority share the secret “wildlife”. The authority can construct an access key of the form “Class A: Expire May 18, 2005:701288fade1f2cdf72a1afc80b88f91b”, where MD5 (“Class A: Expire May 18, 2005:1234:wildlife”) is “701288fade1f2cdf72a1afc80b88f91b”. The message portion of the access key protected message includes, in this example, the content class, expiration date and serial number. Now suppose a content object contains the text “Hello, world!” and belongs to “Class A” and was created on “Nov. 1, 2004”. The authority can construct a content descriptor of the form “Class A: Created Nov. 1, 2004: 3ae249ac3502670aa3f2b714df141ebb”, where MD5 (“Class A: Created Nov. 1, 2004:wildlife:Hello, world!”) is “3ae249ac3502670aa3f2b714df141ebb”. The message portion of the content message includes the content object, the content class and the creation date.

The client attempts to download the content to the trusted device by sending the access key and the content together with the content descriptor to the trusted device. The trusted device authenticates the access key by recalculating the access key message digest using its serial number and the secret. If the key was forged or intended for a device with a different serial number, then the access key message digest computed by the trusted device will not match that sent with the access key and the request would be refused. The trusted device then authenticates the content and the content descriptor by recalculating the content message digest using the content, the content class, the creation date and the secret. Again, if any part of the content message was forged, the content message digest computed by the trusted device will not match that sent with the content and the request would be refused. If both the access key message and the content message are authenticated successfully, then the trusted device would enforce the access control policy. In this example, the content is of “Class A”, and the access key allows “Class A”. Further, the content was created “Nov. 1, 2004” which is earlier than the subscription expiration date of “May 18, 2005”. Therefore, the trusted device would allow the download to take place. However, if the content was newer than the subscription expiration, or if the content was of a different class, then the trusted device would reject the download request.

It should be understood that in some embodiments the content download always takes place, but use of the content is blocked when a forgery or other policy reason requires. This is especially useful when the client is embedded in or runs on the trusted device.

In the previous example, long strings of ASCII-encoded text illustrate one aspect of one embodiment of the invention. In cases where a human end-user is responsible for communicating the access key value to the client, for example by typing it in, representation including some human-readable portions and some seemingly random portions would not be convenient or practical.

Another embodiment of the invention may encode the access key in a compact binary form. The following example is a method for generating access keys for a time-based subscription.

In this example, the access key is a 32-bit quantity for simple implementation on 32-bit microprocessors. This 32-bit quantity can be represented conveniently for the human end-user as ten decimal digits, eight hexadecimal digits, six alphanumeric characters, or various other encodings.

The access key value can serve multiple purposes. Assume subscriptions are distinguished only be expiration dates, not classes. Some of the bits in the access key could be used to represent the expiration date. For example, a predetermined group of eight bits can represent the expiration date as the number of months beyond some fixed reference date. This method would be limited in that only dates up to twenty one years and four months after the reference date could be represented, but this may be acceptable for many applications. The remaining 24 bits are available for the message digest used to authenticate the access key.

If the message digest algorithm used generates more than 24 bits, such as when using the MD5 algorithm, which generates 128 bits, 24 bits of the resulting digest could be chosen. Additionally or alternatively, the digest could be first reduced by combining together its bits by using any number of techniques such as breaking up the digest into smaller pieces and adding the pieces together.

A 24-bit message digest yields 16,777,216 possible unique combinations. While this is a large number in human terms, it is certainly within the computational abilities of an automated system to try all possible values until a valid key could be found. To protect against such a brute-force attack, the trusted device could intentionally insert a delay between the time it is asked by the client to validate a request to download content and the time that the request is accepted or rejected. For example, inserting a five second delay would render a brute force attack against a 24-bit digest impractical as it would take over two years to try every possible combination. A cryptographically stronger solution is to use a larger digest, particularly if enough information can be extracted from a trusted device to emulate its authentication process on a more open computing system.

The content descriptor would typically be stored as a header together with the content in a data file so that there is no need to manage separate objects. However, the content descriptor could also be stored separately.

The client could be a computer program running on a personal computer with a graphical user interface to the end-user. The end-user may request a download, and the client could then provide the access key and content descriptor to the trusted device. Alternatively, the client may be embedded in the trusted device, in which case the end-user would interface with the trusted device directly.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may serve as the authority, client, or trusted devices according to various embodiments of the invention. Further, any part of the system may be located on a single computer or may be distributed among a plurality of computers attached by a communications network. For example, as noted above, the client may be embedded in the trusted device or on a separate computer.

A general-purpose computer system according to one embodiment of the invention is configured to perform any of the described functions. It should be appreciated that the system may perform other functions, including network communication, and the invention is not limited to having any particular function or set of functions.

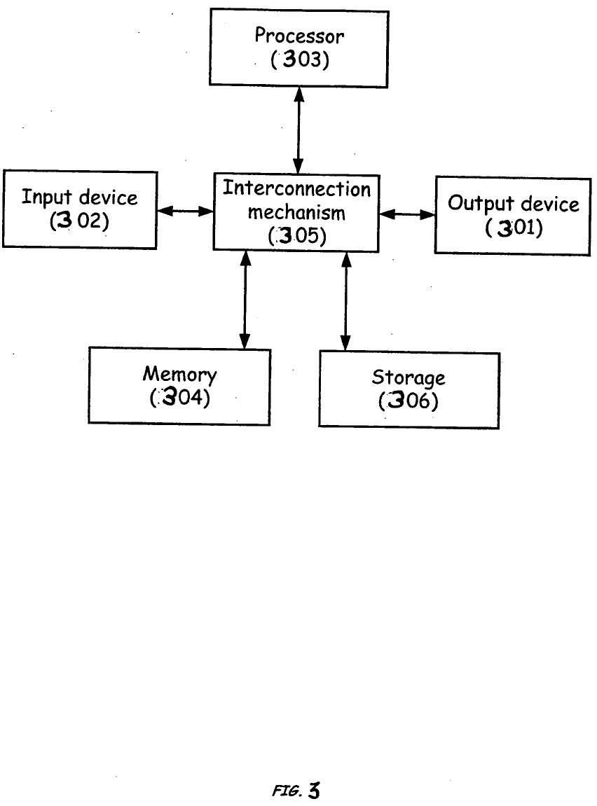

For example, various aspects of the invention may be implemented as specialized software executing in a general-purpose computer system 300 such as that shown in FIG. 3. The computer system 300 may include a processor 303 connected to one or more memory devices 304, such as a disk drive, memory, or other device for storing data. Memory 304 is typically used for storing programs and data during operation of the computer system 300. Components of computer system 300 may be coupled by an interconnection mechanism 305, which may include one or more busses (e.g., between components that are integrated within a same machine) and/or a network (e.g., between components that reside on separate discrete machines). The interconnection mechanism 305 enables communications (e.g., data, instructions) to be exchanged between system components of system 300.

Computer system 300 also includes one or more input devices 302, for example, a keyboard, mouse, trackball, microphone, touch screen, and one or more output devices 301, for example, a printing device, display screen, speaker. In addition, computer system 300 may contain one or more interfaces (not shown) that connect computer system 300 to a communication network (in addition or as an alternative to the interconnection mechanism 305.

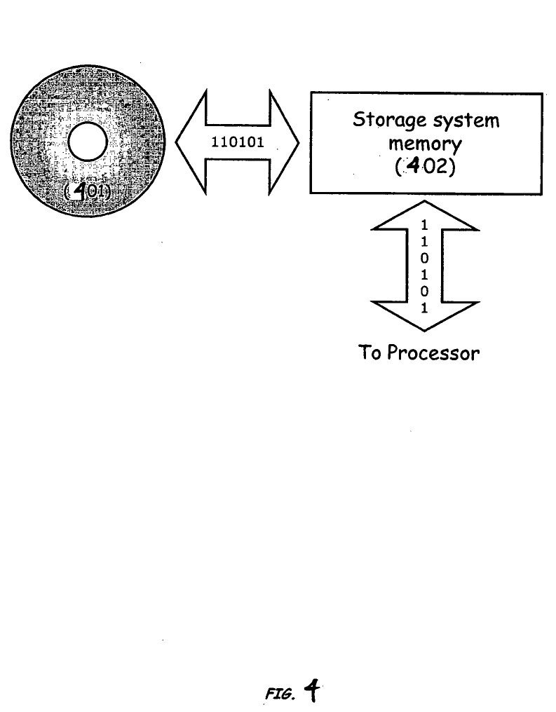

The storage system 306, shown in greater detail in FIG. 4, typically includes a computer readable and writeable nonvolatile recording medium 401 in which signals are stored that define a program to be executed by the processor or information stored on or in the medium 401 to be processed by the program. The medium may, for example, be a disk or flash memory. Typically, in operation, the processor causes data to be read from the nonvolatile recording medium 401 into another memory 402 that allows for faster access to the information by the processor than does the medium 401. This memory 402 is typically a volatile, random access memory such as a dynamic random access memory (DRAM) or static memory (SRAM). It may be located in storage system 306, as shown, or in memory system 304, not shown. The processor 303 generally manipulates the data within the integrated circuit memory 304, 402 and then copies the data to the medium 401 after processing is completed. A variety of mechanisms are known for managing data movement between the medium 401 and the integrated circuit memory element 304, 402, and the invention is not limited thereto. The invention is not limited to a particular memory system 304 or storage system 306.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architecture or components that that shown in FIG. 3.

Computer system 300 may be a general-purpose computer system that is programmable using a high-level computer programming language. Computer system 300 may be also implemented using specially programmed, special purpose hardware. In computer system 300, processor 303 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X operating system available from Apple Computer, the Solaris operating system available from Sun Microsystems, or UNIX operating systems available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of access control in which an authority may limit the content a client may download to a trusted device comprising:
authority making content and a content descriptor containing information about the content available to a client;
authority providing an access key to a client;
client presenting the access key and a requested content descriptor to a trusted device for download; and
the trusted device accepting or rejecting the requested download as determined by the access key and content descriptor presented.

2. The method of claim 1, the access key containing a message digest.

3. The method of claim 2, the message digest including a secret known to the authority and to the trusted device.

4. The method of claim 1, the trusted device containing an identifier; the trusted device providing the identifier to the client; the client providing the identifier to the authority; and the authority using the identifier in generating the access key such that the access key is only valid for trusted devices with the same identifier.

5. The method of claim 4, the identifier being unique, such that the access key is only valid for a specific trusted device.

6. The method of claim 4, the access key containing a message digest, the message digest including the identifier.

7. The method of claim 1, the content descriptor integrated with the corresponding content.

8. The method of claim 7, the content descriptor containing a digest including all or part of the content in a content descriptor.

9. The method of claim 7, the content descriptor containing a digest including all or part of the content descriptor.

10. The method of claim 8, the digest including a secret known to the authority and the trusted device.

11. The method of claim 9, the digest including a secret known to the authority and the trusted device.

12. The method of claim 1, the content being encrypted by a secret known to the authority and the trusted device.

13. The method of claim 1, the content descriptor containing a list of one or more access classes and the access key containing a list of one or more allowed access classes, such that the trusted device will allow access if the content's access classes are included in the access key.

14. The method of claim 13, the access key containing a digest, the digest including the list of allowed classes.

15. The method of claim 1, the content descriptor containing a content creation date and the access key containing an expiration date, such that the trusted device will deny access if the content creation date is newer than the expiration date.

16. The method of claim 15, the access key containing a message digest, the digest including the expiration date.

17. The method of claim 1, the client integrated with the trusted device.

18. The method of claim 1, the content stored on removable storage media.

19. The method of claim 1, the content stored on fixed storage media.

20. The method of claim 1, the content stored on a server, the server connected to a communications network, and the client able to download the content across the network.

21. The method of claim 20, the client able to save the content locally for later retrieval.

22. Apparatus for limiting distribution of content obtained together with an access key in which a shared secret is encoded from a computer executing a server process, comprising:
a trusted device including a verifier that verifies the encoded shared secret and a content acceptor that only accepts content when the shared secret is verified.

23. The apparatus of claim 22, the access key including a message digest covering the shared secret, the trusted device further comprising:
A message digest encoded into which information including the shared secret is fed and which produces a message digest for comparison the access key.
